(19) United States
(12) Patent Application Publication
(10) Pub. No.: US 2006/0009997 A1
(43) Pub. Date: Jan. 12, 2006

(54) Method for transforming subjective data to quantitative information for use in a decision making process

(76) Inventor: Arthur Felix, Camarillo, CA (US)

Correspondence Address: NAVAIRWD COUNSEL GROUP, 575 "I" AVE, SUITE 1 (CODE K00000E), BUILDING 36, ROOM 2308, POINT MUGU, CA, 93042-5049, US

(21) Appl. No.: 10/890,838

(22) Filed: Jul. 12, 2004

(51) Int. Cl. G06Q 99/00

(52) U.S. Cl. 705/1

(57) ABSTRACT

A trade study for developing products for a decision making authority, and guidelines in tailoring the trade study to meet the needs of a program. The trade study transforms a subjective decision making process into an objective decision making process. Within the trade study, standard terms and definitions are used, roles and responsibilities of participants and decision makers are documented, and a flow diagram is provided. The trade study defines a structure, removes cost and risk, defines baseline/optimum solutions, present uncertainty considerations, and presents a cost-benefit chart and a risk-benefit chart.

### BACKGROUND OF THE INVENTION

1. Field of the Invention

The present invention relates generally a decision making process referred to as trade studies. More particularly, the present invention relates to a method which transforms a subjective decision making process into an objective decision making process and which can be applied to a wide variety of decision making processes.

2. Description of the Prior Art

In the past, Trade Studies have been considered failures for rendering wrong decisions in hindsight or not providing the Decision Making Authority with enough credible information for making a correct decision. Past Trade Studies typically repeat poorly documented processes. The complaints on past Trade Studies include the following:
(1) The Trade Study could not be understood by users; and
(2) The Trade Study could not be repeated or reassessed when new information relating to alternatives, criteria or customer needs become available to the users.

During the final presentation of previous Trade Studies to the Decision Making Authority, the following points were often discussed and tended to halt or delay progress toward the rendering of a decision. These points include:
(1) Explanations/reasons for excluding alternatives from the Trade Study.
(2) The criteria or traits used did not properly represent program priorities.
(3) The criteria priority/weighting did not represent program priorities by being biased.
(4) Uncertainty (Lack of Confidence) was not considered in criteria grading.
(5) Criterion scoring was executed without substantiation (lacking a scale or function).
(6) Cost and Risk lost their importance when embedded in the evaluation criteria list.
(7) Marginal winners of the Trade Study (alternatives whose scores were not substantially above the next highest score) were often taken as absolute winners without further reassessment or refinement of the back-up data.
(8) Program time constraints forced the closure of Trade Studies thereby rendering a resolution without completing the Trade Study process.

There is also currently a need to consider the ability to recreate a past Trade Study when new information is available. The Trade Study process should accommodate new information for reassessment such as:
(1) New Viable Alternatives being presented.
(1) New selection criteria or a rethinking of the selection criteria used for evaluation.
(3) A change in the criteria Utility Curves with updated information.
(4) New Priority/Weighting values.
(5) More realistic, higher confidence data points with less uncertainty.
(6) New cost figures.

Accordingly, there is a need to answer each of the in adequacies and issues listed above. Further, the trade study when given to and executed by a trained and knowledgeable trade study lead and decision making authority needs to have a positive impact on the team and management by providing concrete answers for every alternative considered for selection.

### SUMMARY OF THE INVENTION

The trade study method of the present invention overcomes some of the difficulties of the past including those mentioned above in that it comprises a highly efficient and very effective method for performing and documenting a trade study, developing products for an individual or group that has decision making authority and a process/method which is tailorable to meet the needs of a program.

Within the trade study process, standardized terms and definitions are used, roles and responsibilities of the participants and decision makers are documented and a flow diagram illustrating a preferred embodiment of the invention is provided.

The trade study process comprises four phases which consist of an initiate trade study phase, develop trade study matrix phase, an evaluate results phase and a course of action phase.

During the initiate trade study phase a trade study lead initiates the trade study by documenting a purpose/need statement, identifying membership of a trade study team for support, and developing a program plan for the execution of the trade study. The initiate trade study ends when a decision making authority makes a decision at a gate review on the trade study after reviewing and approving viable alternatives, criteria, baseline/optimum solution, and priorities and weighting for the trade study.

During the develop trade study phase, the decision making authority makes the decision to continue with the trade study after approving the viable alternatives, criteria, baseline/optimum solution, and priorities and weightings for the trade study, thus initiating the second phase. The develop trade study phase ends when the trade study team develops each of the viable alternatives to generate scores for each grading criterion and the trade study lead assembles the scores into summary matrixes. The information in the summary matrixes is the basic data used for activities occurring during the evaluate results phase of the trade study.

The evaluate results phase of the trade study begins with the trade study lead having completed summary matrixes which consider the impact of uncertainty in the trade study due to lack of confidence in criteria grades. During the evaluate results phase a cost-benefit chart, a risk-benefit chart, risk mitigation plans are generated and presented to the decision making authority. Issues and concerns are also expressed and documented during this phase. The trade study team also presents the team's recommendations to the decision making authority for a decision at a second review.

During the course of action phase of the trade study, the decision making authority decides to either (1) close the trade study by accepting the data and making a decision on the best course of action for the trade study based on the data compiled during the trade study, or (2) repeat any of the previous steps to reassess the data presented. The latter course of action will require another review at a later date when the action is completed.

The trade study process of the present invention accomplishes the following:
1. Defines a framework and structure for seven often used trade study types.
2. Removes cost and risk from a tradable criteria list.
3. Defines baseline/optimum solutions to anchor criteria utility curves.
4. Presents uncertainty (lack of confidence) considerations in criteria evaluation.
5. Presents a cost-benefit chart for use in a final evaluation.
6. Presents a risk-benefit chart for use in the final evaluation.

### BRIEF DESCRIPTION OF THE DRAWINGS

FIG. 1 illustrates a continuum of a decision making process with respect to increased time and effort;

FIGS. 2A-2D illustrate a flow diagram depicting the program steps for the four phases of the trade study process comprising a preferred embodiment of the present invention;

FIG. 3 is a sample utility curve which depicts the relationship between an alternative grade per criteria and an assigned score for the grade;

FIG. 4 depicts a cost benefit chart for viable alternatives developed from summary matrixes which are products of phase 2 of the trade study; and

FIG. 5 depicts a risk benefit chart which shows relative risk versus high benefit for the viable alternatives being assessed during the trade study.

### DETAILED DESCRIPTION OF THE PREFERRED EMBODIMENT

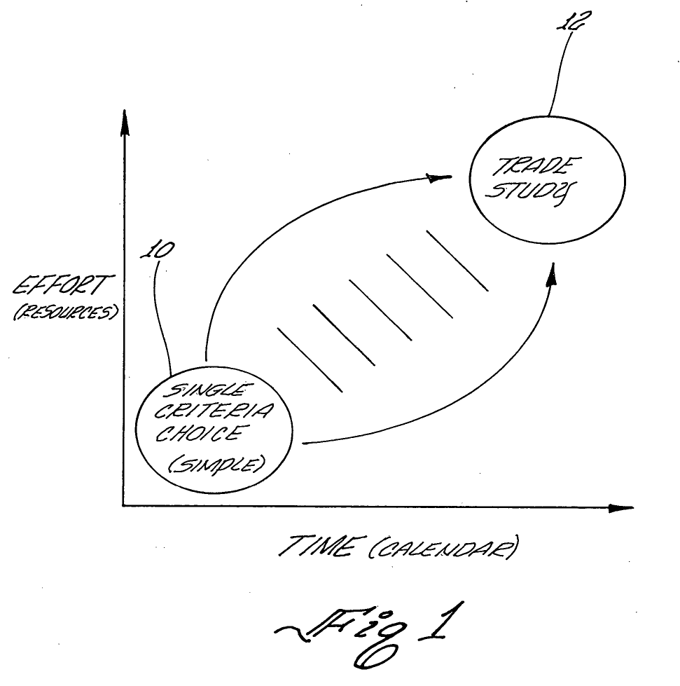

Referring first to FIG. 1, trade studies can range from a simple single criterion choice 10 to a substantially more complete study 12 with multiple products and steps. The simple trade study 10 processes are generally subsets of the more complete trade Study 12 process. Simple trade subsets are used when time, resources, or data are limited. Another reason for using one of these simple subsets is when the Trade Study under consideration is pre-defined as an Informal Trade Study. Typically, an informal trade study is used when program milestones are unaffected by any alternative selection, and all impacts including cost and schedule are contained within a single integrated product team.

Each trade study from 10 to 12 is ultimately dependent on time, resources, or data. The trade study processes referred to in FIG. 1 are briefly described in the trade study subsets section in this application. In the trade subsets section, trade study processes are tailored to meet program time, resources and/or data constraints. The basic process of the invention described herein uses four phases that govern the progress of the trade study, and defines the individuals responsible for the development of the trade study for all trade study subsets described herein. The individual having decision making authority chairs the pre-defined reviews and renders decisions at these reviews. The successful execution of a trade study effort is dependent on the trade study lead and decision making authority understanding the process, the products presented, and the possible course of action that may be directed. Individuals utilizing the trade study process described herein will find significant improvement in team productivity and an alternative selection process which is greatly enhanced.

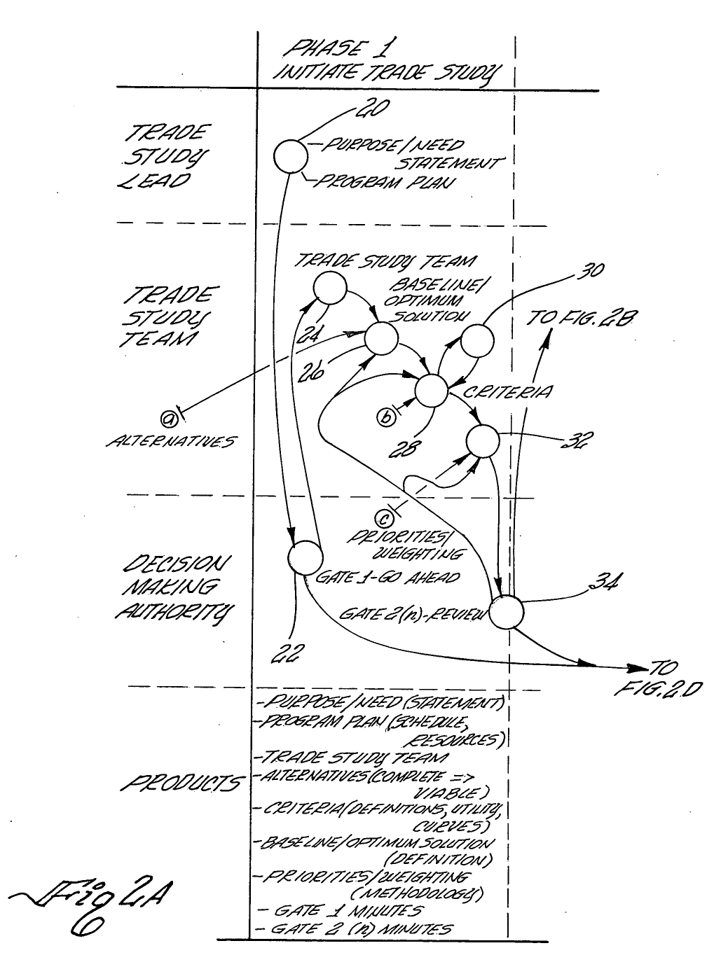

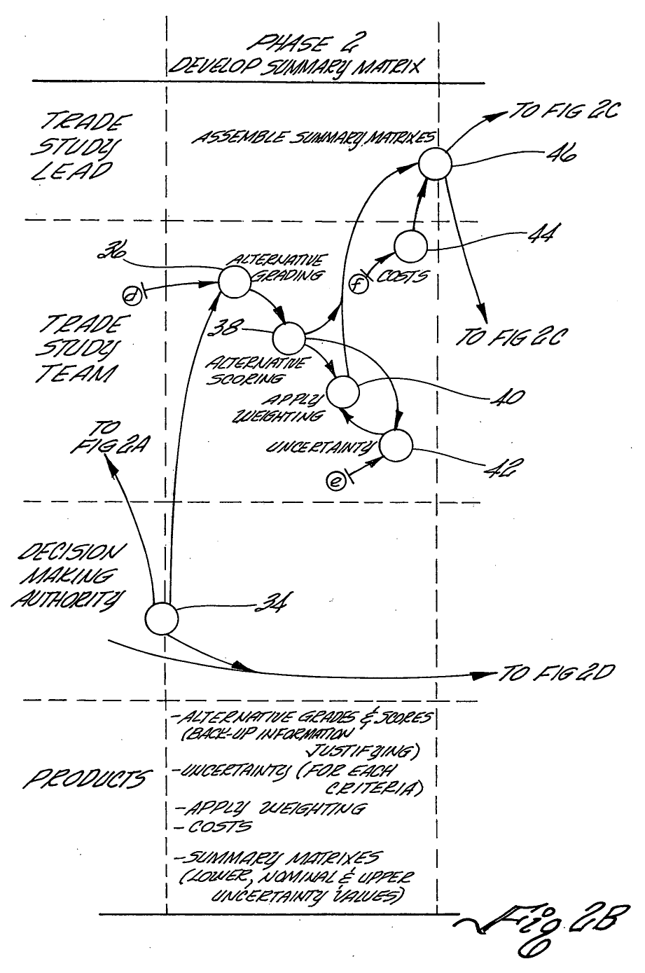

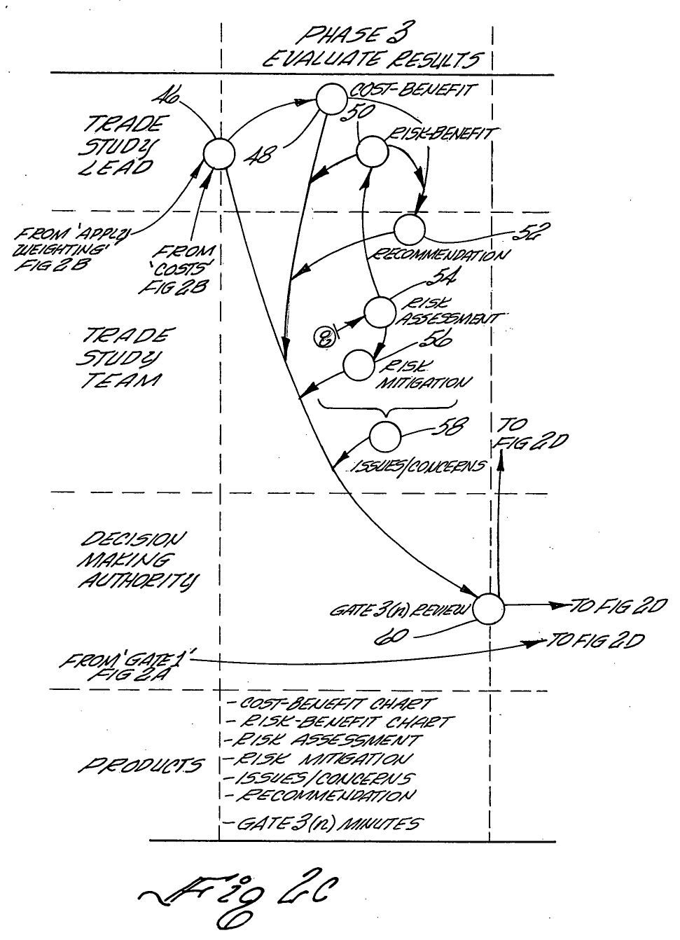

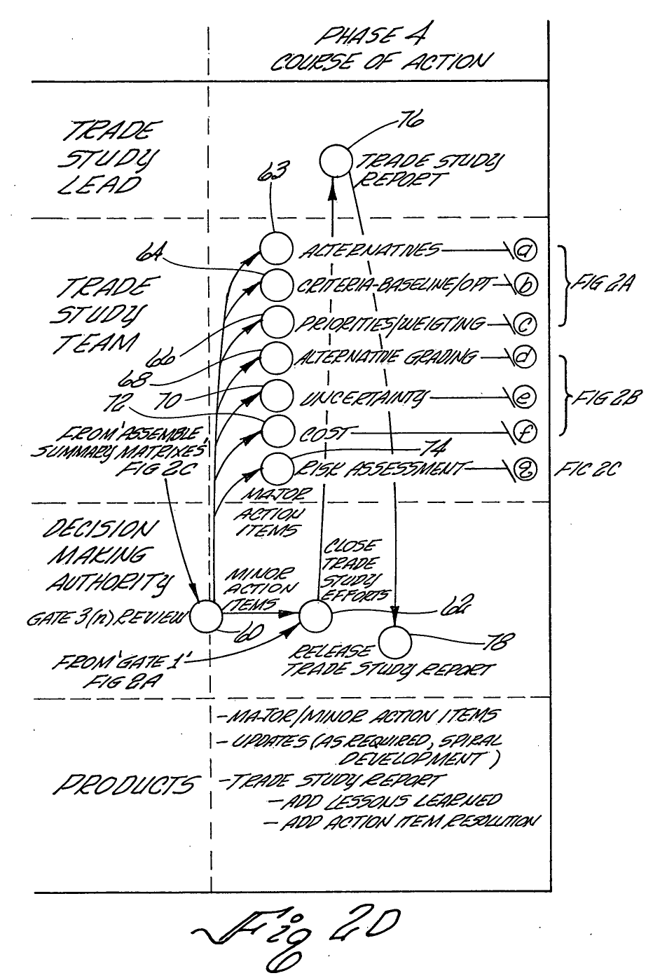

Referring to FIGS. 2A, 2B, 2C and 2D, the complete Trade Study process is divided into four phases which are illustrated in FIGS. 2A-2D. Many aspects of each phase are overlapping, but in moving from one phase to the next, specific products (summary matrix) or reviews (gates) are mandated. Phase 1 is the initiate trade study phase shown in FIG. 2A, Phase 2 is the develop trade study matrix phase shown in FIG. 2B, Phase 3 is the evaluate results shown in FIG. 2C and Phase 4 is the course of action shown in FIG. 2B.

Within each phase, specific responsibilities are assigned to specific individuals. These individuals and their responsibilities are set forth below.

The trade study lead (TSL) is responsible for the trade study. His or her responsibility starts with initiating the trade study, assembling the trade study team and directing the collection of information required to make presentations to the individual having decision making authority for approval and release.

The trade study team (TST) consist of the individuals responsible for supporting the trade study lead by gathering and developing data for the trade study under the direction of the trade study lead. This information is required for the products and presentations to the decision making authority.

The decision making authority (DMA) is the individual or individuals responsible for making decisions on the trade study. These decisions include the trade study go-ahead, approving the members of the trade study team and their required resources, and approving continuation, completion, and any updates to the trade study. The decision making authority is often the program manager or the customer that funds or supplies resources for the trade study and is dependent on the results for subsequent program execution.

Referring to FIG. 2A, the trade study lead initiates the trade study (program step 20) by documenting the purpose/need statement, identifying membership of the trade study team for support of the proposed trade study, and developing the program plan for the execution of the proposed trade study. Phase 1 of the trade study ends when the decision making authority makes the decision at Gate 2(n) (program step 34) on the trade study after reviewing and approving viable alternatives, criteria, baseline/optimum solutions, and priorities/weighting factors. Due to the anticipated iterative nature of Phase 1, there may be more than one Gate 2 review of the proposed trade study.

During Phase 1, the trade study lead documents the specific purpose/need for the trade study and expected results of a selection, consequences resulting from no action, and major program constraints (program step 20). If there are time critical elements, these elements are identified in program step 20 so that the decision making authority is cognizant of these constraints. In order for the decision making authority to fully approve the trade study, a trade study program plan is presented that outlines the scope of effort, participants required (in the form of the prospective trade study team members), and the time schedule for the trade study.

Program step 22 is defined as Gate 1 which provides the go-ahead for the trade study. During program step 22, the trade study lead presents to the decision making authority the purpose/need statement, program plan, and any ground-rules and assumptions that are relevant to this particular trade study. It is at this point (program step 22) that the decision making authority can authorize the start of the trade study, stop work on all activity relating to the trade study, or ask the trade study leader to start work with resources assigned contingent upon completion of specific action items. All presentation materials are included in the Trade Study Report and minutes of the Gate 1 review are documented in an appendix of the trade study report.

Program step 24 is the step during which the trade study team is assembled for the process. Prospective members are presented to the decision making at Gate 1 for review and approval. The decision making authority then finalizes the membership of the trade study team for the duration of the Trade Study. The responsibilities of the trade study team include the development and concurrence of alternatives, criteria, criteria scoring functions (utility curves), criteria priorities/weighting functions, sanctioning a baseline or optimum solution, generating alternative scoring, and supporting the development of cost-benefit and risk-benefit charts for decision making authority review.

During program step 26 two groups of alternatives are developed. The first group of alternatives developed during program step 26 is the inclusive group of all alternatives to be considered. The second group of alternatives developed during program step 26 is the list of viable alternatives. The down select of alternatives in the trade study comes through using go/no-go constraints (program steps 26) which are hard constraints. The go/no-go constraints are absolute constraints in that the alternatives can or cannot meet these specific constraints.

A manageable list of viable alternatives (FIG. 2D) is from three to five alternatives. More than five viable alternatives will likely consume valuable program resources in the trade study. In some instances, all of the original set of alternatives may meet the go/no-go constraints of program step 26, thereby becoming the viable alternatives used in the trade study.

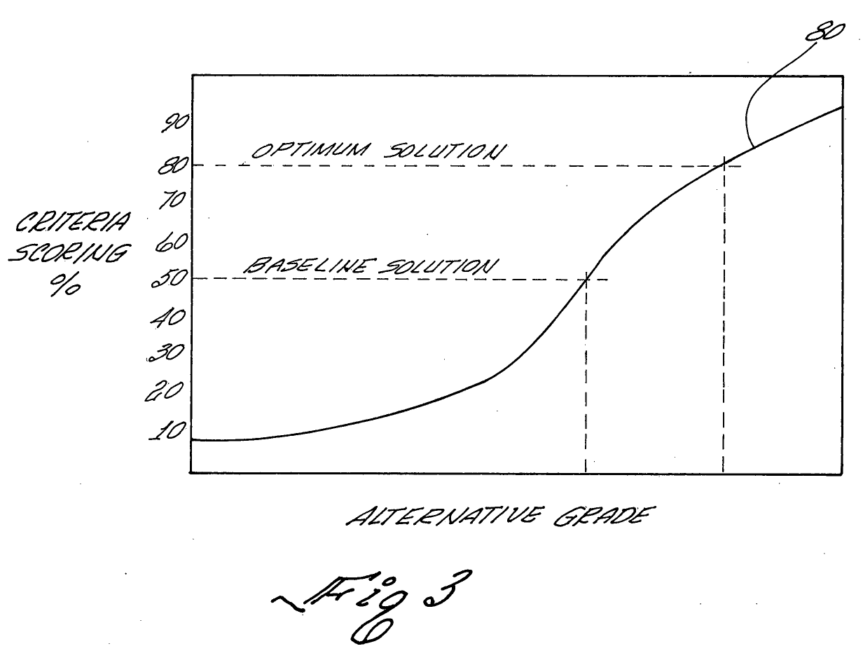

Program steps 28 and 30 relate to criteria which the trade study team establishes. The criteria are to be used in assessing the viable alternatives. The establishment of the criteria includes their definition and scoring functions depicted in utility curves of the type illustrated in FIG. 3. The utility curve relationships of the type depicted in FIG. 3 can take the form of curves, linear relationships, or step functions. The utility curve relationships are developed by the trade study team and the trade study lead. The criteria used for criteria grading are not the hard constraints previously used for go/no-no down-selection of program step 26. There are two basic points that need to be made in program step 26 of the trade study. First is that the trade study assumes that each of the criteria are independent of one another for grading purposes. Criteria dependence requires a multi-dimensional relationship that is beyond the scope of this invention. The second is that the trade study reserves cost and risk for the final evaluation of the viable alternatives in Phase 3 (FIG. 3C), and does not use cost and risk as part of the tradable space in the trade study which removes cost and risk from a tradable criteria list. The importance of cost and risk are reserved for review by the decision making authority at the gate 3(n) review (program step 3(n), FIG. 2C).

During program steps 28 and 30, the number of criteria used for the trade study should number between 3 and 10. Less than three criteria can skew the results dramatically, while more than 10 criteria may be unmanageable and may consume valuable program resources during the trade study.

Referring again to FIGS. 2A and 3, the trade study includes the baseline and optimum solution which is program step 26. The trade study team defines the baseline or optimum solution for the trade study. The baseline and optimum solution are used to anchor a utility curve, an example of which is depicted in FIG. 3. A baseline solution is used when the purpose of a trade study is to study an existing baseline for replacement. An optimum solution is used when a balance of traits or characteristics define an optimum solution that meets system and programmatic constraints.

For the baseline, the utility curves are adjusted, based on expereince, to show the scores of the baseline solution at the 50 percent mark (utility curve 80 at 50%, FIG. 3). This allows trading space for the criteria above and below the baseline. When the optimum solution is used, the utility curves 80 are adjusted, based on experience, to locate scores at the 80 percent level. The expectation is that each of the alternatives not be able to meet the 80 percent value in all criteria grades. This also allows room for improvement, but significant improvement beyond the 80 percent value enters the area of excessive sub-optimization and diminishing returns. These steps in generating the utility curves may be an iterative process within the trade study team facilitated by the trade study lead.

The priority/weighting of criteria are handled in a single tier or a two-tier fashion during program step 32. A single tier method puts each of the criteria on equal footing or importance for consideration. A two-tier method groups the criteria into groups that can be individually prioritized within the group, while the groups can be prioritized against each other. For example, Table I below illustrates a two tier process used for criteria/sub-criteria prioritization/weighting. Values shown in Table I are for illustrative purposes only. All percentages and weightings are defined and substantiated by the trade study team and trade study lead. Both the priorities/weighting and the method used in developing those weightings are documented for presentation to the decision making authority for their understanding and documented in the trade study report for future reference.

TABLE I

| Criteria | Sub-Criteria | Percentages | Ratio |
|---|---|---|---|
| Performance | | 50.0% | 3.3 |
| | speed | 15.0% | 3.0 |
| | acceleration | 15.0% | 3.0 |
| | payload | 10.0% | 2.0 |
| | fuel consumption | 5.0% | 1.0 |
| | ceiling | 5.0% | 1.0 |
| Reliability | | 15.0% | 1.0 |
| | MTBF | 15.0% | 1.0 |
| Safety | | 15.0% | 1.0 |
| | Safety | 15.0% | 1.0 |
| Logistics | | 20.0% | 1.3 |
| | Supply lines | 5.0% | 1.0 |
| | Spare Parts | 5.0% | 1.0 |
| | Crew Training | 10.0% | 2.0 |
| | | 100.0% | 100.0% |

The Gate 2(n) which is the Phase 1 review occurs during program step 34. This is the line of demarcation between set-up work and evaluation of the viable alternatives. This review is used by the trade study lead to present products generated in Phase 1 to the decision making authority. The establishment of viable alternatives, criteria, utility curves, baseline/optimum solutions, and priorities/weighting are reviewed and approved by the decision making authority before proceeding on to the actual grading and scoring of the viable alternatives. The decision making authority may approve the products and signal the continued efforts in the trade study, stop the trade study efforts, or assign actions that require reassessment of the products and another review at a later date. The latter choice would require another Gate 2(n) review before proceeding. The products are incorporated in the trade study report and the Gate 2(n) minutes are included in an appendix of the trade study report.

Referring to FIG. 2B, Phase 2 starts when the decision making authority makes the decision to continue with the trade study after approving the viable alternatives, criteria, baseline/optimum solution, and priorities/weightings at the Gate 2(n) review illustrated in FIG. 2A. Phase 2 ends when the trade study team has developed each of the viable alternatives to generate the scores for each grading criterion and the trade study lead has assembled these scores into summary matrixes. The information in the summary matrixes is the information used for Phase 3 activities. The completion of the summary matrixes is a pseudo gate that the trade study lead uses to signify the completion of Phase 2.

During program step 36 alternative grading occurs. The Viable Alternatives are assembled and developed for evaluation with respect to each of the assigned evaluation criteria. Each alternative is evaluated and assessed per the pre-defined criteria. The trade study team is responsible for gathering and assembling this information.

During program step 38 alternative scoring is processed. Applying each of the alternatives' criteria grade to the utility curve of FIG. 3 translates the criteria grade to a resultant score. This process is repeated for the minimum-maximum (pessimistic-optimistic) grades developed in program step 42, which is entitled uncertainty (lack of confidence).

Program step 40 is the apply weighting program step of Phase 2 of the trade study. The score generated in program step 40 is prioritized/weighted for a weighted score for each criterion. The process of program step 40 uses the same weighting on the minimum-maximum (pessimistic-optimistic) scores developed because of uncertainty or lack of confidence. The uncertainty or lack of confidence is defined in program step 42.

Program step 42 is the uncertainty (lack of confidence) program step of Phase 2 of the trade study. In the evaluation of the viable alternatives, the trade study team has the responsibility of generating a nominal value for the criteria grade, and also determining the uncertainty or lack of confidence of this value. This is an inverse relationship. Considering the alternative value of low confidence, it is expected to have a wider uncertainty in the grade. The process lends itself to a minimum-nominal-maximum grading or a ±3δ value if probabilistic methods are used.

Several past trade studies have used a uniform deviation around the criteria score, typically a ±1 resultant score count without addressing uncertainty (lack of confidnce). This uniform deviation was the basis of past sensitivity studies on the relative positioning of the final results.

In the process of the present invention, the uncertainty of each criteria grade is individually evaluated on the merits of the viable alternative being assessed. This means that each individual criterion will almost always have a different uncertainty spread based on the merits of that criterion for each viable alternative assessed in the trade study.

Program step 44 of the trade study process is the program step in which costs are considered. The costs for each alternative is collected for each viable alternative for the trade study lead. The trade study team is responsible for generating the minimum-nominal-maximum costs for each alternative.

Program step 46 is the assemble summary matrixes step of the trade study. The trade study lead compiles the assembled scores for the viable alternatives into a summary matrix or summary matrixes used to tabulate the information. Table II and Table III is an example of summary matrix. The process is repeated for the upper and lower values or +36 of the score based on uncertainty in the criteria grade.

TABLE II

| | | Alternative A | | Alternative B | |
|---|---|---|---|---|---|
| Summary | Sub- | Cost $ | | Cost $ | |
| Matrix | Weighting | Raw | Weighted | Raw | Weighted |
| Criteria | Criteria | Score | Score | Score | Score |
| Performance | 3.3 | | | | |
| speed | 3.0 | | | | |
| acceleration | 3.0 | | | | |
| payload | 2.0 | | | | |
| fuel | 1.0 | | | | |
| consumption | | | | | |
| ceiling | 1.0 | | | | |
| Reliability | 1.0 | | | | |
| MTBF | 1.0 | | | | |
| Safety | 1.0 | | | | |
| Safety | 1.0 | | | | |
| Logistics | 1.3 | | | | |
| Supply lines | 1.0 | | | | |
| Spare Parts | 1.0 | | | | |
| Crew | 2.0 | | | | |
| Training | | | | | |
| | | | #1 Score | | #2 Score |

TABLE III

| | | Alternative C | | Alternative D | |
|---|---|---|---|---|---|
| Summary | Sub- | Cost $ | | Cost $ | |
| Matrix | Weighting | Raw | Weighted | Raw | Weighted |
| Criteria | Criteria | Score | Score | Score | Score |
| Performance | 3.3 | | | | |
| speed | 3.0 | | | | |
| acceleration | 3.0 | | | | |
| payload | 2.0 | | | | |
| fuel | 1.0 | | | | |
| consumption | | | | | |
| ceiling | 1.0 | | | | |
| Reliability | 1.0 | | | | |
| MTBF | 1.0 | | | | |
| Safety | 1.0 | | | | |
| Safety | 1.0 | | | | |
| Logistics | 1.3 | | | | |
| Supply lines | 1.0 | | | | |
| Spare Parts | 1.0 | | | | |
| Crew | 2.0 | | | | |
| Training | | | | | |
| | | | #3 Score | | #4 Score |

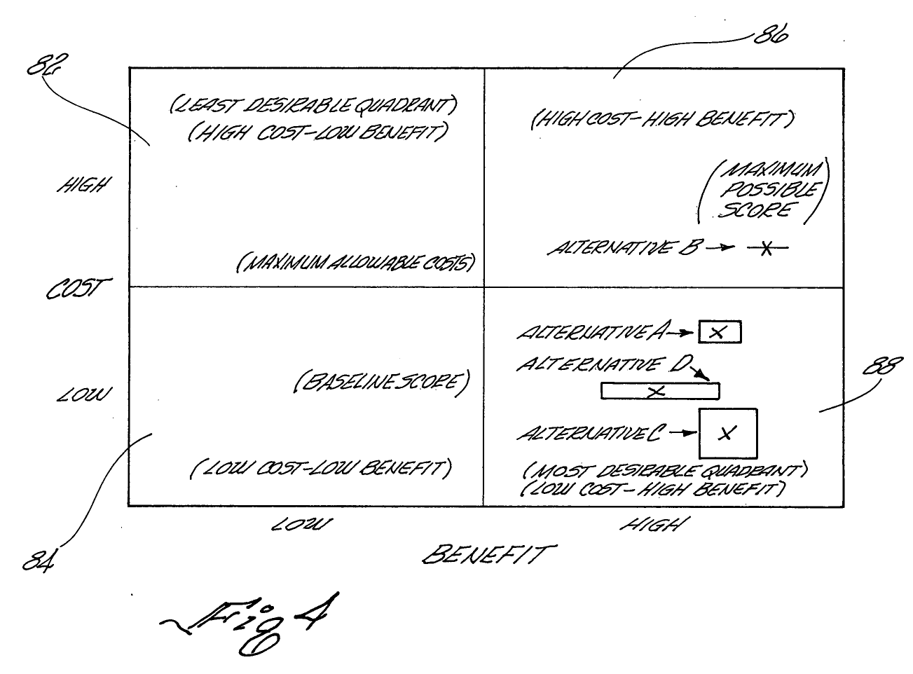

Referring to FIGS. 2C and 4, Phase 3 of the trade study starts with the trade study lead having a completed summary matrix or summary matrixes which consider the impact of the uncertainty due to lack of confidence in the criteria grades. Phase 3 of trade study ends when the trade study lead presents a cost-benefit chart, risk-benefit chart, risk mitigation plan(s), issues and concerns, and the trade study team recommendations to the decision making authority for a decision at the Gate 3(n) review.

The cost-benefit program step 48 is a graphical representation of the results in the summary matrixes which show the relative relationships and potential for future action. In the graphical representation of FIG. 4, the X-axis is the relative worth or final tabulated scores from the summary matrix and the Y-axis is the cost of each viable alternative. The preferred quadrant is in the lower right hand quadrant 88 which is the quadrant that has the highest benefit with the lowest cost. The data from three minimum-nominal-maximum summary matrixes is summarized in a singular Cost-Benefit Chart.

The variation in the final score due to an uncertainty for each alternative score (alternatives A, C and D from Tables II and III) causes the spread along the X-axis in quadrant 88. The uncertainty in the cost of the alternatives A, C and D causes a spread in the Y-axis. The mid-point of the cost-benefit chart X-axis is the point at which all scores are set to the mid-point of the utility curves (FIG. 3). The mid-point of the Y-axis is the maximum allowable cost assigned by the program for a viable alternative to be further considered. Quadrants 82 and 86 are above the maximum allowable cost which would normally eliminate alternative B of Table II from further consideration as a viable alternative. As shown in FIG. 4, there are no viable alternatives from Tables II and III which reside in quadrants 82 and 84.

The relative relationships of the alternative's cost-benefit show how uncertainty can play a significant role in determining the next course of action. X-axis overlaps alternatives A, B, C and D indicate that there is a probability of an incorrect winner of the trade study that increases with the amount of overlap, so that the final scoring positions of the alternatives can change positions. Accordingly, if there is an overlap of the type occurring in FIG. 3, there is no clear alternative to be pursued in the trade study solution. Increased overlap indicates increased ambiguity in final solution positions. Further action as determined in the Gate 3(n) review is required to minimize the uncertainty with the objective of negating the overlap.

This action may be a focused effort on specific criteria that may significantly reduce the uncertainty of the results, thereby decreasing the overlap. The value added due to cost-benefit analysis is lost if cost were included as a criteria for evaluating the viable alternatives.

Program step 54 is the risk assessment program step for the trade study. Each of the viable alternatives in the trade study are assessed for risk. History of past performance may significantly reduce the risk of alternatives being successful.

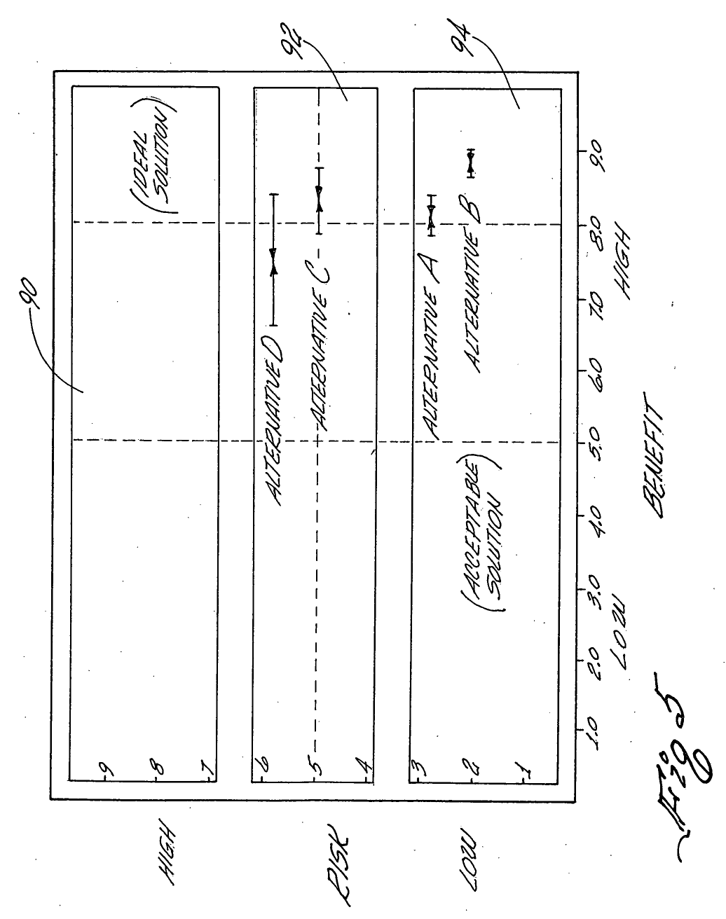

Referring to FIGS. 2C and 5, the risk-benefit program step for the trade study is program step 50. FIG. 5 is a graphical representation of risk assessment which shows the relative relationships and potential for high risk alternatives processed during the trade study. In the graphical representation, the X-axis is the relative worth or final tabulated scores from the summary matrix and the Y-axis is the cost derived from risk assessment. The value added due to risk-benefit analysis would be lost if risk were included as a criteria for evaluating the viable alternatives.

The risk mitigation program step is program step 56 of the trade study. The trade study lead generates a mitigation plan for each moderate or high risk assessed. In the mitigation plan, the direction of further resources are planned so that the end result can be the definition or characterization of a viable alternative that meets the systems needs.

The recommendation program step for Phase 3 of the trade study is program step 52. The trade study lead after compiling the cost-benefit and risk-assessment charts (program steps 48 and 50) presents the team's recommendation on the next course of action to the decision making authority in the gate 3(n) review (program step 60).

The issues/concerns program step is program step 58. During the development of the trade study, several issues or concerns are generated that are not classified as risks, but need to be documented and brought to the attention of the decision making authority.

The Gate 3(n) review which is the Phase 3 review. This review is the gate or program step in which the basic trade study evaluation is complete and the summary data is assembled for presentation to the decision making authority. The primary presentation products at this review are the summary matrixes which provide nominal data along with lower limit data (minimum or −3δ type values) and upper limit data (maximum or +3δ type values) due to uncertainty, cost-benefit chart, risk-benefit chart and the team's recommendation for the next plan of action.

The decision making authority has one of three basic courses of action he may pursue at program step 60. The first course of action is cancellation or stop-work on the trade study and collating for disposition the work completed to date. The second course of action is to approve the recommended alternative with the possibility that minor action items may be required. The third course of action is to reiterate the trade study by revising some of the significant steps previously approved. These are major action items that will require another review by the decision making authority. The anticipation is that any change in the previous steps will alter the final score of the viable alternatives. This would require the respective gate reviews of program steps 34 and 60 before proceeding with the trade study. The products of this Phase are incorporated into the trade study report while the minutes of the Gate 3(n) review are documented and retained in an appendix to the trade study report.

Referring now to FIG. 2D, Phase 4 of the trade study starts when at the end of the Gate 3(n) review (program step 60), the decision making authority has decided to either (1) close the Trade Study by accepting the data and make a decision on the best course of action for the trade study based on the data compiled during the trade study, or (2) repeat any of the previous steps to reassess the data presented. The latter course of action will require another review at a later date when the action is completed.

By closing the trade study (program step 60), the decision making authority has reached a decision on the trade study. The decision may be contingent on completing minor action items. At this point in time, the trade study lead finalizes the trade study report for final release.

The trade study process may also have major action items which need to be reviewed. The decision making authority assigns major action items to the trade study team to re-assess alternatives (program step 63), criteria-baseline/optimum solution (program step 64), priorities/weighting (program step 66), alternative grading (program step 68), uncertainty (program step 70), costs (program step 72), or risk assessment (program step 74). When in this mode, the respective paths are repeated and updated products are provided. The trade study process lends itself to this type of spiral development for updates and refinement of current and pre-existing trade studies.

Program step 76 generates the trade study report. This report contains the summation and explanation of all the activity occurring during and concerning the trade study and an explanation of the products developed. All products developed in the trade study process are used in this report. The report also contains additional information explaining the products along with lessons learned. An outline generally includes the following information:
Executive Summary
Purpose/Need Statement
Ground-rules and Assumptions
Time constraints
Trade Study Schedule
Trade Study Costs/Savings
Technical Summary (products)
Responsible Integrated Product Team
Lessons Learned
Appendix A—Gate 1, Trade Study Go-Ahead
Appendix B—Gate 2(n), Trade Study Mid-Review
Appendix C—Gate 3(n), Trade Study Close Out Review
Appendix D—Back-up information

The release of the trade study report occurs during program step 78. Releasing the trade study report requires final approval of the decision making authority. The released trade study report resides in the program's repository for decision making.

The major action items are covered in program steps 63-74. The decision making authority at his or their discretion, may require that one or more of the major steps in the trade study be re-assessed and possibly revised for another Gate 3(n) review (program step 60). The decision making authority has the option of having any or all of the following major steps reassessed:
Alternatives (program step 63);
Criteria, Utility Curves, Baseline/Optimum solution (s) (program step 64);
Priorities/Weighting (program step 66);
Alternative grading (program step 68);
Alternative Score Confidence/Uncertainty (program step 70);
Costs (program step 72); and/or
Risk Assessment (program step 74).

The trade study process includes trade study subsets. Circumstances arise when the complete trade study process is not applicable, the program then provides a less complex subset of the trade study process. The following are short descriptions of the trade study subsets, which are a tailored version of the complete trade study process. Each of the trade study subsets below generally fit in the structure and framework identified in FIGS. 2A-2D. The only changes required are some tasks and products in Phase 1 and Phase 2. The steps in Phases 3 and 4 are the same for all trade study subsets. Therefore, once the general concepts of the trade study process are fully understood, they can be applied to all trade study subsets with confidence and accurate results for the program.

The first trade study subset is the single criterion choice. This is the simplest of all subjective decision making methods. This method is used when there is only one criterion available for the decision making authority for decision making. The decision making authority makes the decision among viable alternatives based on the merits of a singular criterion.

The second trade study subset is the pros/cons trade-off study. The pros/cons method of a trade-off study occurs when each viable alternative is judged by a listing of pros and cons. This method can be used when more than one criterion is known. This type of trade-off study is generally divided into two major groupings. The first grouping occurs when the pros and cons are independent and unique from alternative to alternative. The second grouping occurs when each of the alternatives listed contains and is judged by the same characteristics or criteria.

The third trade study subset is the multiple criteria selection method. In utilizing the multiple criteria selection method, the selection is based on a scale that is used to judge the subjective relative worth of each criteria. This requires some quantitative knowledge or value of the criteria relative to one another. This also is more of a relative relationship as opposed to the absolute relationship in the pros/cons trade-off study. The implies equal weighting and importance in each criterion.

The fourth trade study subset is the Pugh Controlled Convergence. The Pugh Controlled Convergence requires a defined baseline solution which the alternatives are compared with. Each criterion being evaluated is judged by being either significantly better or worse than the baseline. The alternative with the most positives is considered the optimum alternative for the trade study using this selection or iterative process. This implies equal weighting and importance in the criterion of the Pugh Controlled Convergence.

The fifth trade study subset is the relative comparison (basic) method. In the relative comparison method, the multiple criteria selection method is taken one step further in that the relative benefit over a baseline carries more weight than merely being better. In this method, a priority is given to the criteria that is subjective, but it is based on the level of improvement over the baseline selection.

The sixth trade study subset is the relative comparison (advanced) method. In this more advanced comparison method the evaluation needs to add the priority or weighting of the specific criteria being assessed. The weighting shows the programmatic importance of each criterion. At this step, a complete utility curve is required to graph the importance of the criteria grade as it relates to a standard scoring system. At this level, a generic sensitivity study is performed.

The seventh trade study subset is the complete trade study. The elevation of the more advanced relative comparison to a complete trade study is the use of a go/no-go filter in selecting the viable alternatives subset from the complete set of alternatives. Uncertainty (lack of confidence) is used to define a minimum-nominal-maximum grade.

The use of the cost-benefit chart, risk-benefit chart, and the risk assessment at the end of the trade study are recommended for all trade study types.

What is claimed is:

1. A trade study method for developing products for a decision making authority, and guidelines in tailoring the trade study method to meet requirements for a program, said trade study method comprising:
(a) initiating said trade study by preparing a need and purpose statement for said trade study, said trade study being initiated by a trade study lead;
(b) identifying membership selected from a group of potential members for a trade study team for developing and supporting a program plan for executing said trade study;
(c) developing a first group of alternatives and a second of alternatives for said trade study, said first group of alternatives being an inclusive group of alternatives being considered by said trade study team during said trade study, and said second group of alternatives being viable alternatives generated by said trade study team.
(d) developing a baseline and optimum solution, grading criterion, and priorities and weighting factors for said grading criterion, said baseline and optimum solution, said grading criterion and said priorities and weighting factors being developed by said trade study team;
(f) making a first decision to continue said trade study after reviewing and then approving said viable alternatives, said baseline and optimum solution, said grading criterion and said priorities and weighting factors, said decision making authority making said first decision to continue said trade study;
(g) processing each of said viable alternatives to generate scores for each of said grading criterion;
(h) assembling said scores for each of said grading criterion into summary matrixes, said scores being assembled into said summary matrixes by said trade study lead, said summary matrixes containing information and data used for activities occurring during an evaluate results phase of said trade study;
(f) generating a cost-benefit chart which depicts a graphical representation of results from said summary matrixes wherein said cost-benefit chart has an x-axis and y-axis, the X-axis of said cost-benefit chart representing final tabulated scores from the summary matrixes and the Y-axis of said cost-benefit chart representing cost for each of said viable alternatives;
(g) generating a risk-benefit chart which depicts a graphical representation of risk assessment for said trade study, wherein said risk-benefit chart has an x-axis and y-axis, the X-axis of said risk-benefit chart representing the final tabulated scores from the summary matrixes and the Y-axis of said risk-benefit chart representing cost for each of said viable alternatives derived from said risk assessment, wherein said trade study team generates said cost-benefit chart and said risk-assessment chart;
(h) providing said cost-benefit chart and said risk-assessment charts to said trade study lead for said trade study lead to present a recommendation to said decision making authority on a next course of action for said trade study; and
(i) closing said trade study by making a second decision to take a course of action approving a recommended alternative of said viable alternatives for said trade study, said decision making authority approving said recommended alternative for said trade study.

2. The trade study method of claim 1 further comprising the step of generating a mitigation plan for each of said viable alternatives which has a moderate risk assessment or a high risk assessment representation in said risk-benefit chart.

3. The trade study method of claim 1 further comprising the steps of:
(a) documenting issues and concerns generated during said trade study which are not classified as risk by said trade study team; and
(b) presenting said issues and concerns to said decision making authority.

4. The trade study method of claim 1 further comprising the steps of:
(a) gathering cost for each of the viable alternatives of said trade study;
(b) generating minimum-nominal-maximum costs for each of the viable alternatives of said trade study, said trade study team generating the minimum-nominal-maximum costs for each of the viable alternatives of said trade study; and
(c) generating minimum-nominal-maximum criteria for said cost-benefit chart and said risk-benifit chart. of said trade study.

5. The trade study method of claim 1 wherein each of the priority and weighting factors for said grading criterion are assigned a specific weight.

6. The trade study method of claim 1 wherein each of the priority and weighting factors for said grading criterion are individually prioritized within a group, and groups of the priority and weighting factors are prioritized against one another.

7. The trade study method of claim 1 wherein a manageable list of viable alternatives for said trade study comprises from three to five viable alternatives.

8. The trade study method of claim 1 wherein said decision making authority closes the trade study with a contingency list of minor action items, said trade study method requiring completion of said contingency list of minor action items by said trade study team prior to closing said trade study.

9. A trade study method for developing products for a decision making authority, and guidelines in tailoring the trade study method to meet requirements for a program, said trade study method comprising:
(a) initiating said trade study by preparing a need and purpose statement for said trade study, said trade study being initiated by a trade study lead;
(b) identifying membership selected from a group of potential members for a trade study team for developing and supporting a program plan for executing said trade study;
(c) developing a first group of alternatives and a second of alternatives for said trade study, said first group of alternatives being an inclusive group of alternatives being considered by said trade study team during said trade study, and said second group of alternatives being a list of viable alternatives generated by said trade study team, wherein the list of viable alternatives for said trade study comprises from three to five viable alternatives;
(d) developing a baseline and optimum solution, grading criterion, and priorities and weighting factors for said grading criterion, said baseline and optimum solution, said grading criterion and said priorities and weighting factors being developed by said trade study team;
(f) making a first decision to continue said trade study after reviewing and then approving said viable alternatives, said baseline and optimum solution, said grading criterion and said priorities and weighting factors, said decision making authority making said first decision to continue said trade study;
(g) processing each of said viable alternatives to generate scores for each of said grading criterion;
(h) assembling said scores for each of said grading criterion into summary matrixes, said scores being assembled into said summary matrix by said trade study lead, said summary matrixes containing information and data used for activities occurring during an evaluate results phase of said trade study;
(f) generating a cost-benefit chart which depicts a graphical representation of results from said summary matrixes wherein said cost-benefit chart has an x-axis and y-axis, the X-axis of said cost-benefit chart representing final tabulated scores from the summary matrixes and the Y-axis of said cost-benefit chart representing cost for each of said viable alternatives;
(g) generating a risk-benefit chart which depicts a graphical representation of risk assessment for said trade study, wherein said risk-benefit chart has an x-axis and y-axis, the X-axis of said risk-benefit chart representing the final tabulated scores from the summary matrixes and the Y-axis of said risk-benefit chart representing cost for each of said viable alternatives derived from said risk assessment, wherein said trade study team generates said cost-benefit chart and said risk-assessment chart;
(h) providing said cost-benefit chart and said risk-assessment charts to said trade study lead for said trade study lead to present a recommendation to said decision making authority on a next course of action for said trade study;
(i) closing said trade study by making a second decision to take a course of action approving a recommended alternative of said viable alternatives for said trade study, said decision making authority approving said recommended alternative for said trade study; and
(j) generating a trade study report at a conclusion for said trade study, said trade study report containing a summation and an explanation of the activities occurring during and concerning said trade study and an explanation of said products developed during the trade study.

10. The trade study method of claim 9 further comprising the step of generating a mitigation plan for each of said viable alternatives which has a moderate risk assessment or a high risk assessment representation in said risk-benefit chart.

11. The trade study method of claim 9 further comprising the steps of:
(a) documenting issues and concerns generated during said trade study which are not classified as risk by said trade study team; and
(b) presenting said issues and concerns to said decision making authority.

12. The trade study method of claim 9 further comprising the steps of:
(a) gathering cost for each of the viable alternatives of said trade study;
(b) generating minimum-nominal-maximum costs for each of the viable alternatives of said trade study, said trade study team generating the minimum-nominal-maximum costs for each of the viable alternatives of said trade study; and
(c) generating minimum-nominal-maximum criteria for said cost-benefit chart and said risk-benifit chart. of said trade study.

13. The trade study method of claim 9 wherein each of the priority and weighting factors for said grading criterion are assigned a specific weight.

14. The trade study method of claim 9 wherein each of the priority and weighting factors for said grading criterion are individually prioritized within a group, and groups of the priority and weighting factors are prioritized against one another.

15. The trade study method of claim 9 wherein said 2decision making authority closes the trade study with a contingency list of minor action items, said trade study method requiring completion of said contingency list of minor action items by said trade study team prior to closing said trade study.

16. A trade study method for developing products for a decision making authority, and guidelines in tailoring the trade study method to meet requirements for a program, said trade study method comprising:
(a) initiating said trade study by preparing a need and purpose statement for said trade study, said trade study being initiated by a trade study lead;
(b) identifying membership selected from a group of potential members for a trade study team for developing and supporting a program plan for executing said trade study;
(c) developing a first group of alternatives and a second of alternatives for said trade study, said first group of alternatives being an inclusive group of alternatives being considered by said trade study team during said trade study, and said second group of alternatives being a list of viable alternatives generated by said trade study team, wherein the list of viable alternatives for said trade study comprises from three to five viable alternatives.
(d) developing a baseline and optimum solution, grading criterion, and priorities and weighting factors for said grading criterion, said baseline and optimum solution, said grading criterion and said priorities and weighting factors being developed by said trade study team;
(f) making a first decision to continue said trade study after reviewing and then approving said viable alternatives, said baseline and optimum solution, said grading criterion and said priorities and weighting factors, said decision making authority making said first decision to continue said trade study;
(g) processing each of said viable alternatives to generate scores for each of said grading criterion;
(h) assembling said scores for each of said grading criterion into summary matrixes, said scores being assembled into said summary matrix by said trade study lead, said summary matrixes containing information and data used for activities occurring during an evaluate results phase of said trade study;
(f) generating a cost-benefit chart which depicts a graphical representation of results from said summary matrixes wherein said cost-benefit chart has an x-axis and y-axis, the X-axis of said cost-benefit chart representing final tabulated scores from the summary matrixes and the Y-axis of said cost-benefit chart representing cost for each of said viable alternatives;
(g) generating a risk-benefit chart which depicts a graphical representation of risk assessment for said trade study, wherein said risk-benefit chart has an x-axis and y-axis, the X-axis of said risk-benefit chart representing the final tabulated scores from the summary matrixes and the Y-axis of said risk-benefit chart representing cost for each of said viable alternatives derived from said risk assessment, wherein said trade study team generates said cost-benefit chart and said risk-assessment chart;
(h) generating a mitigation plan for each of said viable alternatives which has a moderate risk assessment or a high risk assessment representation in said risk-benefit chart.
(i) providing said cost-benefit chart, said risk-assessment charts and said mitigation plan to said trade study lead for said trade study lead to present a recommendation to said decision making authority on a next course of action for said trade study;
(j) closing said trade study by making a second decision to take a course of action approving a recommended alternative of said viable alternatives for said trade study, said decision making authority approving said recommended alternative for said trade study;
(k) continuing said trade study whenever said decision making authority determines a need to review major action items prior to closing said trade study, said major action items to be reviewed by said trade study team including said baseline and optimum solution, said grading criterion, and said priorities and weighting factors for said grading criterion, said trade study team providing updated when a review of said major action items is completed by said trade study team; and
(1) generating a trade study report at a conclusion for said trade study, said trade study report containing a summation and an explanation of the activities occurring during and concerning said trade study and an explanation of said products developed during the trade study.

17. The trade study method of claim 16 further comprising the step of generating a mitigation plan for each of said viable alternatives which has a moderate risk assessment or a high risk assessment representation in said risk-benefit chart.

18. The trade study method of claim 16 further comprising the steps of:
(a) documenting issues and concerns generated during said trade study which are not classified as risk by said trade study team; and
(b) presenting said issues and concerns to said decision making authority.

19. The trade study method of claim 16 further comprising the steps of:
(a) gathering cost for each of the viable alternatives of said trade study;
(b) generating minimum-nominal-maximum costs for each of the viable alternatives of said trade study, said trade study team generating the minimum-nominal-maximum costs for each of the viable alternatives of said trade study; and
(c) generating minimum-nominal-maximum criteria for said cost-benefit chart and said risk-benifit chart. of said trade study.

20. The trade study method of claim 16 wherein said decision making authority closes the trade study with a contingency list of minor action items, said trade study method requiring completion of said contingency list of minor action items by said trade study team prior to closing said trade study.
